(19) United States
(12) Patent Application Publication
(10) Pub. No.: US 2026/0323488 A1
(43) Pub. Date: Oct. 15, 2026

(54) COMMUNICATION METHOD AND WIRELESS COMMUNICATION DEVICE

(71) Applicant: MEDIATEK INC., Hsinchu City (TW)

(72) Inventor: Bang-Chyuan Wang, Hsinchu City (TW)

(21) Appl. No.: 19/176,719

(22) Filed: Apr. 11, 2025

(51) Int. Cl. H04W 48/16; H04W 48/20; H04W 56/00

(52) U.S. Cl. CPC H04W 48/16; H04W 48/20; H04W 56/0015

(57) ABSTRACT

A communication method and a wireless communication device are provided. The communication method comprises: performing a service discovery to obtain at least one service identification by a wireless communication device; performing an Aware beacon filtering procedure according to the at least one service identification by the wireless communication device; disabling a master rank comparison for an anchor master selection (AMS); determining whether the wireless communication device is an anchor master; if the wireless communication device is the anchor master, setting a master rank to a predetermined value; if the wireless communication device is the anchor master, transmitting an Aware beacon with a proprietary attribute.

### TECHNICAL FIELD

The disclosure relates in general to an operation method and an electronic device, and more particularly to a communication method and a wireless communication device.

### BACKGROUND

Wi-Fi Aware extends the Wi-Fi capability with quick discovery, connection, and data exchange with other Wi-Fi devices—without the need for a traditional network infrastructure, internet connection, or GPS signal. Wi-Fi Aware provides rich here-and-now experiences by establishing independent, device-to-device Wi-Fi connections based on a user’s immediate location and preferences.

The Wi-Fi Aware may be used in several application scenarios. For example, the Wi-Fi aware could be used to connect with people nearby to play a favorite game on mobile devices, securely send a document to a printer without first logging onto the network, bring enhanced educational experiences to students visiting a museum, art-gallery, and field trips, enable autonomous and remote-controlled vehicles to instantly become aware of other devices and automatically exchange information such as GPS coordinates, altitude, direction, and owner ID.

### SUMMARY

The disclosure is directed to a communication method and a wireless communication device. An isolated Aware cluster is created to prevent interference from another devices.

According to one embodiment, an communication method is provided. The Aware communication method comprises: performing a service discovery to obtain at least one service identification by a wireless communication device; performing an Aware beacon filtering procedure according to the at least one service identification by the wireless communication device; disabling a master rank comparison for an anchor master selection (AMS); determining whether the wireless communication device is an anchor master; if the wireless communication device is the anchor master, setting a master rank to a predetermined value; if the wireless communication device is the anchor master, transmitting an Aware beacon with a proprietary attribute.

According to another embodiment, a communication method is provided. A communication method is provided. The communication method comprises: performing a service discovery to obtain at least one service identification by a wireless communication device; performing an Aware beacon filtering procedure according to the at least one service identification by the wireless communication device; disabling a master rank comparison for an anchor master selection (AMS); determining whether the wireless communication device is an anchor master; and if the wireless communication device is not the anchor master, joining an Aware cluster according to a service identification.

According to another embodiment, a wireless communication device is provided. The wireless communication device comprises a transceiver and a Wi-Fi module. The transceiver is for wirelessly transmitting and receiving data. The wireless module is coupled to the transceiver. The wireless module is used to execute an Aware communication method. The Aware communication method comprises: performing a service discovery to obtain at least one service identification; performing an Aware beacon filtering procedure according to the at least one service identification; disabling a master rank comparison for an anchor master selection (AMS); determining whether the wireless communication device is an anchor master; if the wireless communication device is the anchor master, setting a master rank to a predetermined value; if the wireless communication device is the anchor master, transmitting an Aware beacon with a proprietary attribute.

### BRIEF DESCRIPTION OF THE DRAWINGS

FIG. 1 illustrates a Wi-Fi Aware scenario according to one embodiment of the present disclosure.

FIG. 2 illustrates a drift of the timing synchronization function (TSF) in the Wi-Fi aware scenario.

FIG. 3 shows the TSF drift according to one embodiment of the present disclosure.

FIGS. 4 to 5 illustrate a Wi-Fi Aware communication method according to one embodiment of the present disclosure.

FIG. 6 shows a flowchart of the Wi-Fi Aware communication method according to one embodiment of the present disclosure.

FIG. 7 illustrates the Wi-Fi Aware communication method according to another embodiment of the present disclosure.

FIG. 8 illustrates a wireless communication device in accordance with an implementation of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

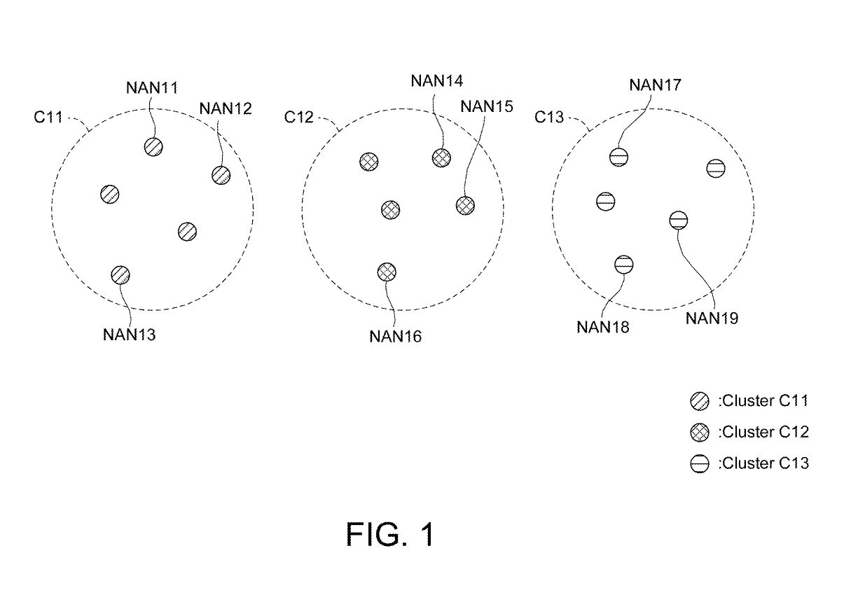

Please refer to FIG. 1, which illustrates a Wi-Fi Aware scenario according to one embodiment of the present disclosure. As shown in the FIG. 1, there are a plurality of wireless communication devices NAN11 to NAN19, etc. in one open space. The wireless communication devices NAN11 to NAN19 are, for example, Neighbor Awareness Networking (NAN) devices. For example, wireless communication devices NAN11 to NAN19 are smartphones, laptops, mart home appliances, or the combination thereof.

In the FIG. 1, there are many Aware clusters C11, C12, C13 for different services using this technique simultaneously. For example, in the Aware cluster C11, the wireless communication devices NAN11, NAN12, NAN13 share photos to classmates by using the Wi-Fi Aware in the class. In the Aware cluster C12, the wireless communication devices NAN14, NAN15, NAN16 send video to family members by using the Wi-Fi Aware in a basketball court. In the Aware cluster C13, the wireless communication devices NAN17, NAN18, NAN19 play music with friends by using the Wi-Fi Aware in a field trip.

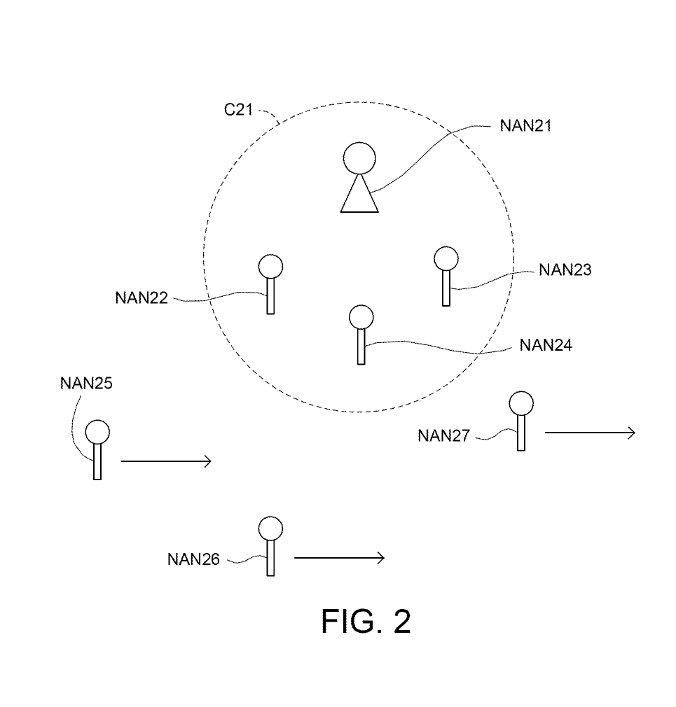

Please refer to FIG. 2, which illustrates a drift of the timing synchronization function (TSF) in the Wi-Fi aware scenario. In the example shown in the FIG. 2, a wireless communication device NAN21, which is a babysitter, uses the Wi-Fi Aware to range the wireless communication devices NAN22, NAN23, NAN24, which are children in the park.

However, when the wireless communication device NAN5, NAN2, or NAN27 using the Wi-Fi Aware walks through the park, the babysitter, i.e. the wireless communication device NAN21, may lost the location of children, such as the wireless communication devices NAN22, NAN23, or NAN24, due to the timing synchronization function (TSF) drift of original Aware cluster.

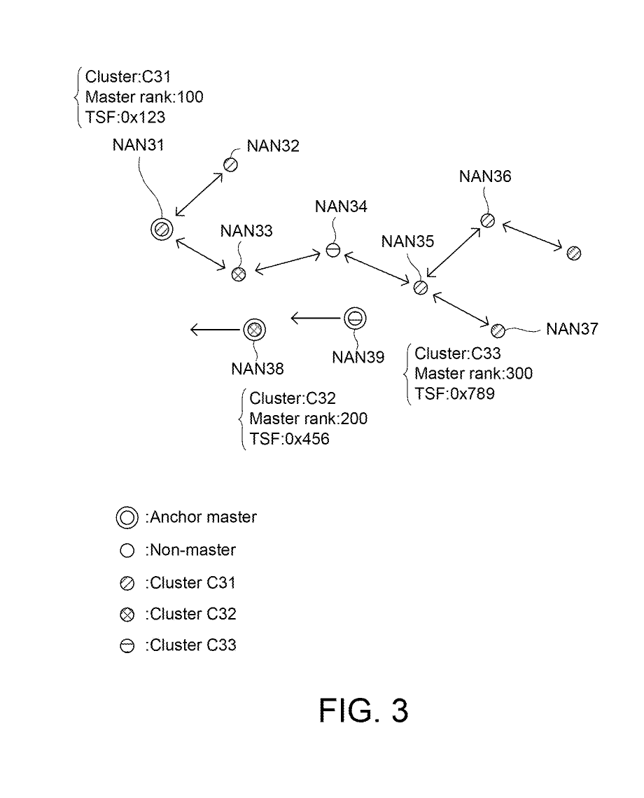

Please refer to FIG. 3, which shows the TSF drift according to one embodiment of the present disclosure. If many wireless communication devices NAN31 to NSN39 using the Wi-Fi Aware work at the same time, the network becomes unstable.

For example, the wireless communication devices NAN32 to NAN37 have been synchronized with the wireless communication device NAN31, which is the anchor master. The mask rank of the wireless communication device NAN31 is “100”.

However, when the wireless communication device NAN38, which is another anchor master having a higher master rank, i.e., “200”, passes through the wireless communication device NAN33, there would be a TSF draft issue. Moreover, when the wireless communication device NAN39, which is another anchor master having a higher master rank, i.e., “300”, passes through the wireless communication device NAN34, there would be a TSF draft issue.

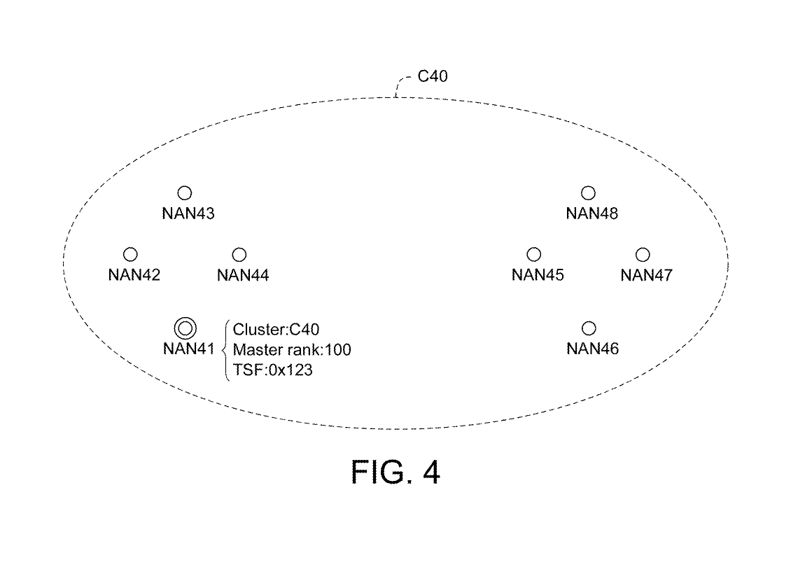

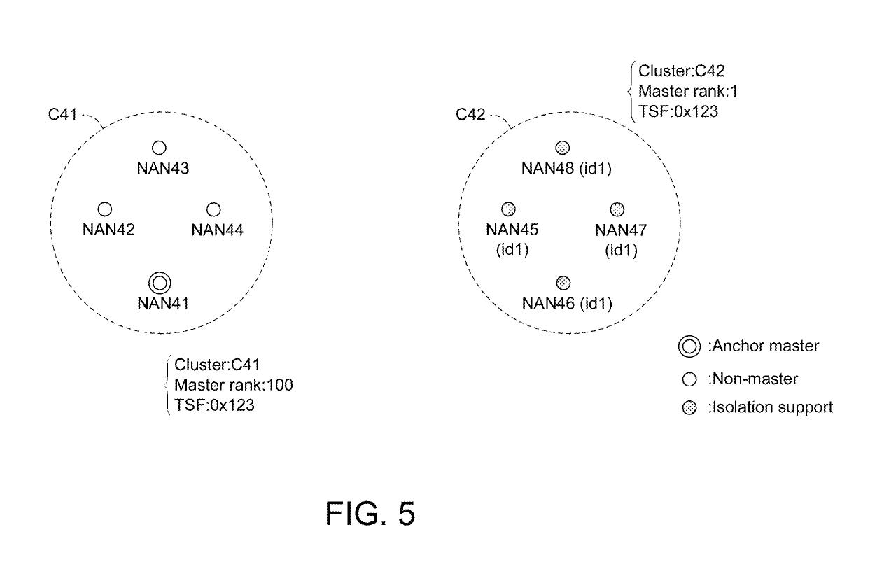

In order to prevent the TSF drift, a Wi-Fi Aware communication method is provided in this disclosure. Please refer to FIGS. 4 to 5, which illustrate the Wi-Fi Aware communication method according to one embodiment of the present disclosure. At the beginning, as shown in the FIG. 4, there is a big group of one Aware cluster C40. The master rank of the wireless communication device NAN41, which is an anchor master, is “100”, and the TSF of the wireless communication device NAN41 is “0x123”.

As shown in the FIG. 5, the wireless communication devices NAN45 to NAN48 go into group isolation mode after doing service discovery. For example, the Aware cluster C40 is divided into an Aware cluster C41 and an Aware cluster C42. The wireless communication devices NAN45, NAN46, NAN47, NAN48 having isolation support are grouped in the Aware cluster C42. In the Aware cluster C42, the wireless communication device NAN48 is an anchor master, and the wireless communication devices NAN45, NAN46, NAN47 are non-masters. The wireless communication device NAN48, which is an anchor master, transmits the Aware beacons with a service identification id1. The wireless communication devices NAN45, NAN46, NAN47, which are non-masters, join the Aware cluster C42 according to the service identification id1.

The wireless communication devices NAN45, NAN46, NAN47, NAN48 in the Aware cluster C42 skip the master rank comparison for an anchor master selection (AMS), so the TSF of the wireless communication devices NAN45, NAN46, NAN47, NAN48 would not be changed, even if another anchor master with higher master rank passes through. Once any another anchor master passes through the Aware cluster C42, the wireless communication devices NAN45, NAN46, NAN47, NAN48 in the Aware cluster C42 would be kept at the Aware cluster C42.

Furthermore, the mask rank of the wireless communication device NAN48, which is the anchor mask, is set to a predetermined value which is lower than 100, such as “1”. The mask rank of all other wireless communication devices NAN41, NAN42, NAN43, NAN44 is “100” which is higher than this predetermined value, so all other wireless communication devices NAN41, NAN42, NAN43, NAN44 would not join the Aware cluster C42.

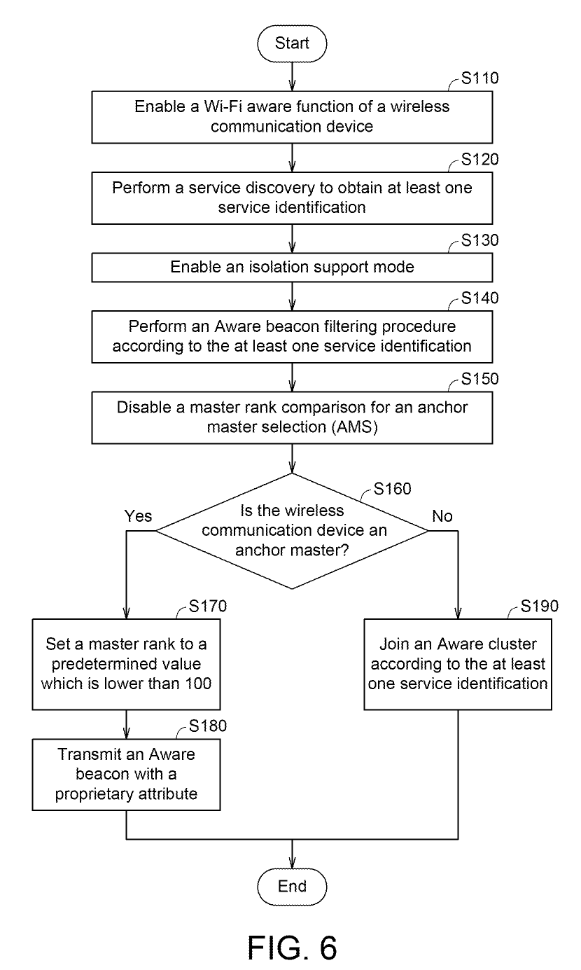

Based on the description in the FIG. 5, an isolated Aware cluster, such as the Aware cluster C42, is created. This isolated Aware cluster C42 is stable without TSF drift. In order to create this isolated Aware cluster, the Wi-Fi Aware communication method is provided for the wireless communication device which is the anchor master or the non-master. Please refer to FIG. 6, which shows a flowchart of the Wi-Fi Aware communication method according to one embodiment of the present disclosure. The Wi-Fi Aware communication method comprises step S110 to S190. The following uses the wireless communication device NAN48 in the FIG. 5 as an example to illustrate the anchor master that executes the Wi-Fi Aware communication method in the FIG. 6, and uses the wireless communication device NAN45 in the FIG. 5 as an example to illustrate the non-master that executes the Wi-Fi Aware communication method in the FIG. 6.

In the step S110, a Wi-Fi aware function of the wireless communication device NAN48 (or the wireless communication device NAN45) is enabled. In this step, the Wi-Fi aware function is enabled via clicking a particular button on a touch panel, or the Wi-Fi aware function is automatically enable when a particular application is executed.

Then, in the step S120, a service discovery is performed to obtain the at least one service identification id1. The service for the service identification id1 is, for example, to connect with people nearby to play a favorite game on mobile devices, to securely send a document to a printer without first logging onto the network, to bring enhanced educational experiences to students visiting a museum, art-gallery, and field trips, to enable autonomous and remote-controlled vehicles to instantly become aware of other devices and automatically exchange information such as GPS coordinates, altitude, direction, and owner ID.

Next, in the step S130, an isolation support mode is enabled.

Then, in the step S140, an Aware beacon filtering procedure is performed according to the at least one service identification id1. For example, in the Aware beacon filtering procedure, only the Aware beacons with the at least one service identification id1 is listened. Any other Aware beacon with other service identification is not listened.

Afterwards, in the step S150, the master rank comparison for the anchor master selection (AMS) is disabled. That is to say, the master rank comparison for the AMS is skipped. The timing synchronization function (TSF) of the wireless communication device NAN48 (or the wireless communication device NAN45) enabling the isolation support mode is kept when another anchor master with higher master rank is approached.

Next, in the step S160, whether the wireless communication device is an anchor master is determined. If the wireless communication device is the anchor master, the process proceeds to the steps S170 and S180; if the wireless communication device is not the anchor master, the process proceeds to the step S190. Therefore, the wireless communication device NAN48 will next execute the steps S170 and S180; the wireless communication device NAN45 will next execute the step S190.

In the step S170, the master rank is set to a predetermined value which is lower than 100. For example, the master rank is set to 1. Because the master rank is set to 1, so all other wireless communication devices NAN41, NAN42, NAN43, NAN44 with higher master rank would not join this Aware cluster C42. This Aware cluster C42 is isolated for the wireless communication devices NAN45, NAN46, NAN47, NAN48 with isolation support.

Then, in the step S180, an Aware beacon with a proprietary attribute is transmitted. The proprietary attribute comprises a group isolation support bit and the at least one service identification id1.

In the step S190, the wireless communication device NAN45 joins the Aware cluster C42 according to the at least one service identification id1.

According to the embodiment described above, the isolated Aware cluster, such as the Aware cluster C42, is created. This isolated Aware cluster C42 is stable without TSF drift.

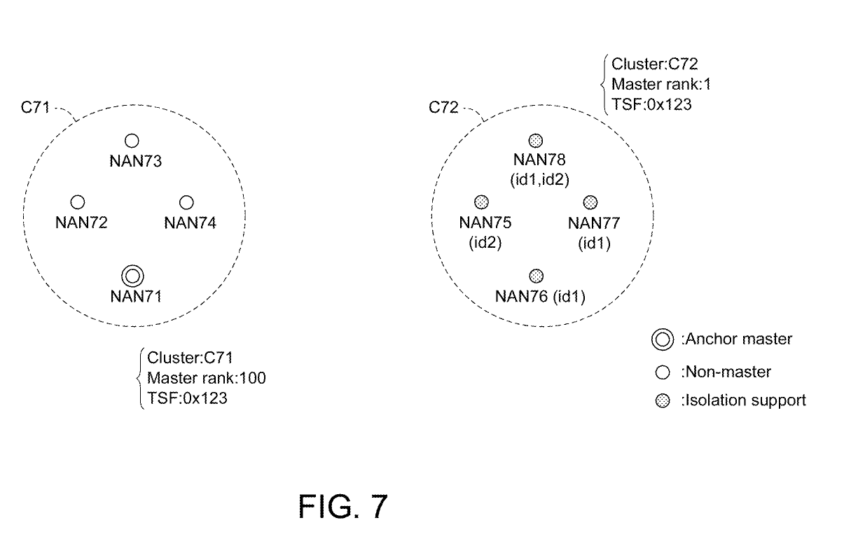

In another embodiment, an isolated Aware cluster could be used for more than one services. The number of the service identifications could be equal to or more than two, and is not used to limit the present disclosure. Please refer to FIG. 7, which illustrates the Wi-Fi Aware communication method according to another embodiment of the present disclosure. The wireless communication devices NAN71 to NAN78 go into group isolation mode after doing service discovery. For example, an Aware cluster C71 and an Aware cluster C72 are created. The wireless communication devices NAN75, NAN76, NAN77, NAN78 having isolation support are grouped in the Aware cluster C72. In the Aware cluster C72, the wireless communication device NAN78 is an anchor master, and the wireless communication devices NAN75, NAN76, NAN77 are non-masters. The wireless communication device NAN78, which is the anchor master, transmits the Aware beacons with the service identification id1 and a service identification id2. The wireless communication devices NAN76, NAN77, which are non-masters, join the Aware cluster C72 according to the service identification id1. The wireless communication device NAN75, which is a non-master, joins the Aware cluster C72 according to the service identification id2.

According to the embodiment described above, the isolated Aware cluster C72 with more than one service identifications is created. This isolated Aware cluster C72 is stable without TSF drift.

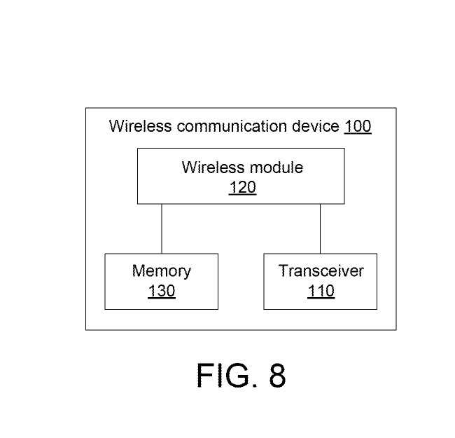

Please refer to FIG. 8, which illustrates a wireless communication device 100 in accordance with an implementation of the present disclosure. The wireless communication device 100 may perform various functions to implement schemes, techniques, processes and methods described herein.

The wireless communication device 100 comprises a transceiver 110, a Wi-Fi module 120 and a memory 130. The transceiver 110 may be capable of wirelessly transmitting and receiving data. In some implementations, the transceiver 110 may be capable of wirelessly communicating with different types of wireless networks of different Wi-Fi technologies. In some implementations, the transceiver 110 may be equipped with a plurality of antenna ports (not shown) such as, for example, four antenna ports. That is, the transceiver 110 may be equipped with multiple transmit antennas and multiple receive antennas for multiple-input multiple-output (MIMO) wireless communications.

The Wi-Fi module 120 is coupled to the transceiver 110. In one aspect, the Wi-Fi module 120 may be implemented in the form of one or more single-core processors, one or more multi-core processors, or one or more CISC or RISC processors. The Wi-Fi module 120 may comprise multiple processors in some implementations and a single processor in other implementations in accordance with the present disclosure. In another aspect, the Wi-Fi module 120 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, the processor is a special-purpose machine specifically designed, arranged and configured to perform specific tasks including those pertaining to the wireless communication behavior for failed registration and service requests for emergency services fallback in mobile communications in accordance with various implementations of the present disclosure.

The memory 130 is coupled to the Wi-Fi module 120 and stores data therein. The memory 130 may comprise a type of random-access memory (RAM) such as dynamic RAM (DRAM), static RAM (SRAM), thyristor RAM (T-RAM) and/or zero-capacitor RAM (Z-RAM). Alternatively, or additionally, the memory 113 may comprise a type of read-only memory (ROM) such as mask ROM, programmable ROM (PROM), erasable programmable ROM (EPROM) and/or electrically erasable programmable ROM (EEPROM). Alternatively, or additionally, the memory 130 may comprise a type of non-volatile random-access memory (NVRAM) such as flash memory, solid-state memory, ferroelectric RAM (FeRAM), magnetoresistive RAM (MRAM) and/or phase-change memory.

The Wi-Fi module 120 of the wireless communication device 100, is configured to perform operations described as above.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A communication method, comprising:
performing a service discovery to obtain at least one service identification by a wireless communication device;
performing an Aware beacon filtering procedure according to the at least one service identification by the wireless communication device;
disabling a master rank comparison for an anchor master selection (AMS);
determining whether the wireless communication device is an anchor master;
if the wireless communication device is the anchor master, setting a master rank to a predetermined value; and
if the wireless communication device is the anchor master, transmitting an Aware beacon with a proprietary attribute.

2. The communication method according to claim 1, wherein in the Aware beacon filtering procedure, the Aware beacon with the at least one service identification is listened.

3. The communication method according to claim 1, wherein a timing synchronization function (TSF) of the wireless communication device enabling the isolation support mode is kept when another anchor master with higher master rank is approached.

4. The communication method according to claim 1, wherein the master rank is set to 1.

5. The communication method according to claim 1, wherein the proprietary attribute comprises a group isolation support bit and the at least one service identification.

6. The communication method according to claim 1, wherein a number of the at least one service identification is equal to or more than two.

7. The communication method according to claim 1, wherein a predetermined value is a value smaller than 100.

8. A communication method, comprising:
performing a service discovery to obtain at least one service identification by a wireless communication device;
performing an Aware beacon filtering procedure according to the at least one service identification by the wireless communication device;
disabling a master rank comparison for an anchor master selection (AMS);
determining whether the wireless communication device is an anchor master; and
if the wireless communication device is not the anchor master, joining an Aware cluster according to a service identification.

9. The communication method according to claim 8, wherein in the Aware beacon filtering procedure, the Aware beacon with the at least one service identification is listened.

10. The communication method according to claim 8, wherein a timing synchronization function (TSF) of the wireless communication device enabling the isolation support mode is kept when another anchor master with higher master rank is approached.

11. The communication method according to claim 8, wherein the master rank is set to 1.

12. The communication method according to claim 8, wherein the proprietary attribute comprises a group isolation support bit and the at least one service identification.

13. The communication method according to claim 8, wherein a number of the at least one service identification is equal to or more than two.

14. A wireless communication device, comprising:
a transceiver, for wirelessly transmitting and receiving data; and
a wireless module, coupled to the transceiver, wherein the wireless module is used to execute an Aware communication method, comprising:
performing a service discovery to obtain at least one service identification;
performing an Aware beacon filtering procedure according to the at least one service identification;
disabling a master rank comparison for an anchor master selection (AMS);
determining whether the wireless communication device is an anchor master;
if the wireless communication device is the anchor master, setting a master rank to a predetermined value; and
if the wireless communication device is the anchor master, transmitting an Aware beacon with a proprietary attribute.

15. The wireless communication device according to claim 14, wherein in the Aware beacon filtering procedure, the Aware beacon with the at least one service identification is listened.

16. The wireless communication device according to claim 14, wherein a timing synchronization function (TSF) of the wireless communication device enabling the isolation support mode is kept when another anchor master with higher master rank is approached.

17. The wireless communication device according to claim 14, wherein the master rank is set to 1.

18. The wireless communication device according to claim 14, wherein the proprietary attribute comprises a group isolation support bit and the at least one service identification.

19. The wireless communication device according to claim 14, wherein a number of the at least one service identification is equal to or more than two.

20. The wireless communication device according to claim 14, wherein a predetermined value is a value smaller than 100.
